(19) United States
(12) Patent Application Publication
(10) Pub. No.: US 2025/0137849 A1
(43) Pub. Date: May 1, 2025

(54) GROUND REFERENCE TARGET AND VICARIOUS RADIOMETRIC CALIBRATION SYSTEM INCLUDING THE SAME

(71) Applicants: KOREA RESEARCH INSTITUTE OF STANDARDS AND SCIENCE, Daejeon (KR); KOREA AEROSPACE RESEARH INSTITUTE, Daejeon (KR)

(72) Inventors: Seon Do LIM, Daejeon (KR); Dong Hoon Lee, Sejong-si (KR); Dong Hwan Cha, Daejeon (KR); Doo Chun Seo, Daejeon (KR)

(73) Assignees: KOREA RESEARCH INSTITUTE OF STANDARDS AND SCIENCE, Daejeon (KR); KOREA AEROSPACE RESEARCH INSTITUTE, Daejeon (KR)

(21) Appl. No.: 18/927,070

(22) Filed: Oct. 25, 2024

(30) Foreign Application Priority Data
Oct. 27, 2023 (KR) 10-2023-0145325

(51) Int. Cl. G01J 5/80

(52) U.S. Cl. CPC G01J 5/802; G01J 5/804

(57) ABSTRACT

Disclosed is a vicarious radiometric calibration system. More specifically, disclosed is a ground reference target for calibrating a digital signal that is obtained through a sensor when a landmark is observed from a satellite or an airplane by using a spectral reflection factor or spectral emissivity of the ground reference target and a vicarious radiometric calibration system including the same. It is possible to derive accurate measurement results for the MWIR region by installing a ground reference target having predetermined reflectance or emissivity and having a special form on the ground with respect to the calibration of a sensor for remote exploration, such as aviation, space, and astronomy, and performing absolute radiometric calibration by using images that are obtained through the ground reference target.

### BACKGROUND

### 1. Technical Field

The present disclosure relates to a vicarious radiometric calibration system, and particularly, to a ground reference target for calibrating a digital signal that is obtained through a sensor when a landmark is observed from a satellite or an airplane by using a spectral reflection factor or spectral emissivity of the ground reference target and a vicarious radiometric calibration system including the same.

### 2. Related Art

The observing of a landmark by a sensor of a satellite or an airplane may be considered as measuring radiance of an observation target. A process of converting a digital number (DN), that is, a digital signal of the sensor for the observation, into a radiance value having secured traceability when the DN is converted into the radiance value is called absolute radiometric calibration.

A method that is widely used, radiometric calibration methods, includes a vicarious among the absolute radiometric calibration method.

The vicarious radiometric calibration method is a method of measuring radiance of a natural or artificial reference target placed on the ground while operating for absolute radiometric calibration of a sensor that is used in remote observation on a satellite or airplane platform, calibrating the measured radiance into a value in a stage right before the sensor at the top of the atmosphere through atmosphere modeling compensation, and calibrating a digital number (DN), that is, a digital signal of the sensor, based on the value.

In this case, a reference value is provided by measuring the ground reference target by a sensor that has been well calibrated and that has secured traceability in another satellite or airplane or on the ground in an almost matching way.

Over the past 20 years, the vicarious radiometric calibration has been widely adopted and used internationally as means for independently guaranteeing the quality of aviation and space remote observation data in each country. FIG. 1 illustrates images of “Gravel plains”, “Sand”, “Disturbed gravel”, and “Dry Grass” which are used as natural ground reference targets for the vicarious radiometric calibration in a conventional long-wave infrared ray (LWIR) region and spectral emissivity thereof. In addition, in the case of a spectral reflection factor, Tarp, that is, an artificial reference target fabricated as a tarpaulin sheet, is also used as an alternative to the natural reference target.

Wavelength regions for the vicarious radiometric calibration basically include visible ray (VIS), near-infrared ray (NIR), and long-wave infrared ray (LWIR) regions. Solar energy that is reflected by a reference target is used in the VIS region, and radiant energy of a reference target itself is used in the LWIR region. That is, reflectance of the reference target is used in the VIS region, and emissivity of the reference target is used in the infrared regions.

Recently, there is a need for the vicarious radiometric calibration in a medium-wave infrared (MWIR) region. However, the existing natural reference target or artificial reference target has a limit in that the existing natural reference target or artificial reference target is not suitable as a reference target in the MWIR region.

The reason for this is that it is preferred that the spectral radiation characteristic of the natural reference target or artificial reference target is uniform depending on a wavelength, but most of materials other than water or metal have a characteristic in that the materials are greatly changed depending on a wavelength in the MWIR region.

FIG. 2 is a diagram illustrating total spectral reflectance of sand, among the conventional natural reference targets illustrated in FIG. 1. Referring to FIG. 2, a relation between emissivity (E) and reflectance (R) can be simply converted like “E=1−R” because a material having a predetermined thickness or more, such as sand, does not have transmissivity.

As illustrated in FIG. 2, it may be seen that a spectral reflection factor or spectral emissivity in the LWIR region is uniform within several % depending on a wavelength, whereas the spectral reflection factor or the spectral emissivity in the MWIR region is greatly changed. It may be seen that sand is not preferred as a reference target because sand causes computational complexity in performing absolute radiometric calibration on the DN value of a spectrum sensor due to such spectrum characteristics.

### PRIOR ART DOCUMENT

### Patent Document

Korean Patent No. 10-1702187 (Jan. 25, 2017)

### SUMMARY

Various embodiments are directed to providing a ground reference target that is installed on the ground by substituting a natural reference target for vicarious radiometric calibration that is required upon ground observation in the MWIR region.

Furthermore, various embodiments are directed to providing a system that obtains images of spectrum radiance by using a ground reference target that is installed on the ground and performs absolute radiometric calibration on the MWIR region based on the images.

In an embodiment, a ground reference target is a structure that is installed on the ground. The ground reference target may include a body part that has the width of M (M is a rational number) meters, the height of N (N is a rational number) meters, that has an upper part opened, and that has an internal space in which water is accommodated formed therein, and an upper plate part that is coupled to the top of the body part, in which a plurality of cells is formed, and that is made of a metal material. A perforation having a predetermined diameter may be formed in each of the plurality of cells. Average radiance of a metal region and a perforation region for each cell may be observed because at least one cell corresponds to one pixel of a sensor upon photographing of the sensor.

Reflectance or emissivity of each of the plurality of cells may be determined by the diameter of the perforation.

A surface of the upper plate part may be processed by sanding or a processing method for diffusion reflection other than the sanding so that the size of reflectance or emissivity is regular according to an observation angle.

The reflectance may be determined to have a number between 0 and 1 depending on the diameter of the perforation or a material on a surface of the upper plate part. The sum of the reflectance and the emissivity may be 1.

Furthermore, in an embodiment, a vicarious radiometric calibration system may include one or more ground reference targets installed on the ground and each including at least one metal region and perforation region and in which a plurality of cells each having predetermined reflectance or emissivity is formed, a sensor mounted on an airplane that flies at a predetermined altitude above an Earth's surface and configured to photograph the ground reference target and to obtain an image in which average radiance for each cell is observed as each of the plurality of cells corresponds to at least one pixel of the sensor, and a vicarious radiometric calibration apparatus configured to calibrate the sensor or the image by using the digital number of the sensor that receives the image as a reference value.

The ground reference target may include a body part that has the width of M meters, the height of N meters, that has an upper part opened, and that has an internal space in which water is accommodated formed therein, and an upper plate part that is coupled to the top of the body part, in which a plurality of cells each having a perforation having a predetermined diameter is formed, and that is made of a metal material.

The vicarious radiometric calibration apparatus may include an atmosphere calibration unit configured to receive the image obtained by the sensor and to perform atmosphere calibration with reference to an atmospheric profile, a digital number extraction unit configured to extract the DN from which the sensor and an influence of current atmosphere have been removed from the image to which the atmosphere calibration has been applied and to convert the DN into radiance, a temperature conversion unit configured to convert the radiance into a radiation temperature based on a measured value of emissivity of the ground reference target, and a calibration value calculation unit configured to calculate a calibration value (ODN) by comparing the radiation temperature and a reference radiation temperature and to calibrate the DN by providing the calibration value (SDN) to the digital number extraction unit.

The atmospheric profile may include one or more of a temperature, humidity, and pressure according to current atmosphere conditions.

According to the embodiments of the present disclosure, it is possible to derive accurate measurement results for the MWIR region by installing a ground reference target having predetermined reflectance or emissivity and having a special form on the ground with respect to the calibration of a sensor for remote exploration, such as aviation, space, and astronomy, and performing absolute radiometric calibration by using images that are obtained through the ground reference target.

### BRIEF DESCRIPTION OF THE DRAWINGS

FIG. 1 is a diagram illustrating images and spectral emissivity of natural ground reference targets for vicarious radiometric calibration in a conventional long-wave infrared (LWIR) region.

FIG. 2 is a diagram illustrating total spectral reflectance of “Sand”, among the conventional natural reference targets illustrated in FIG. 1.

FIGS. 3A and 3B illustrate a perspective view and plan view of an appearance structure of a ground reference target according to an embodiment of the present disclosure.

FIG. 4 is a diagram illustrating a surface state upon sanding processing for a metal material that is used in an upper plate part of the ground reference target according to an embodiment of the present disclosure and spectral emissivity thereof.

FIG. 5 is a diagram illustrating a structure of a vicarious radiometric calibration system including the ground reference target according to an embodiment of the present disclosure.

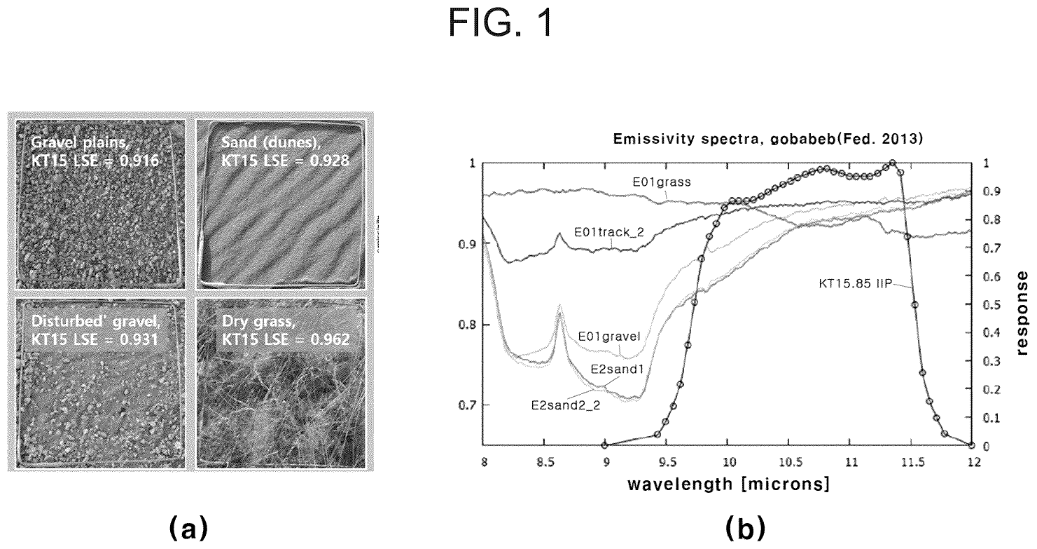

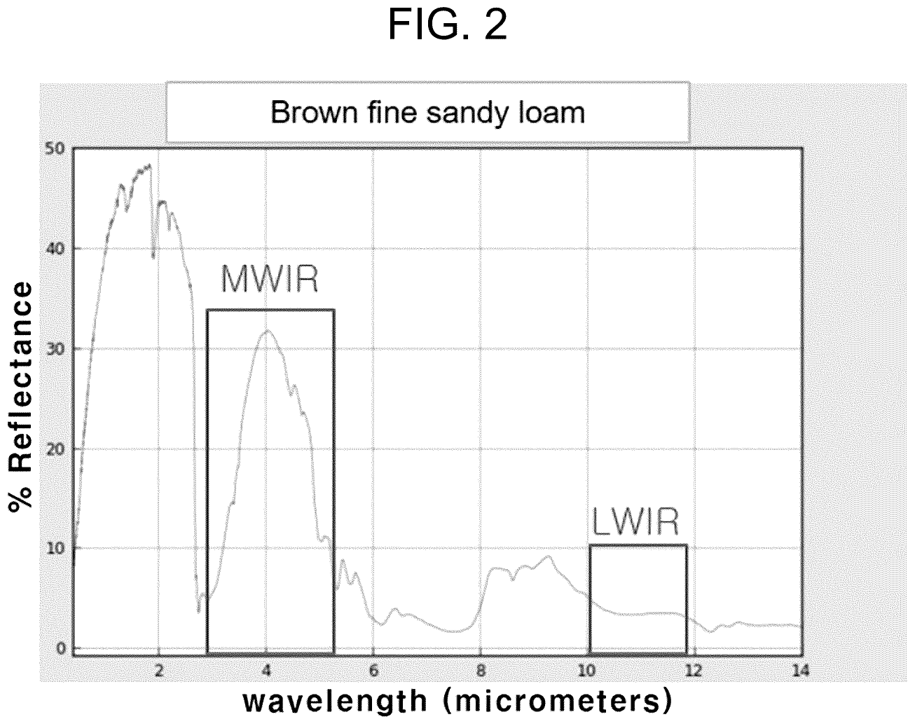

### DETAILED DESCRIPTION

Hereinafter, embodiments of the present disclosure are described in detail with reference to the accompanying drawings and embodiments.

It is to be noted that technological terms used in the present disclosure are used to describe only specific embodiments and are not intended to limit the present disclosure. Furthermore, the technological terms used in the present disclosure should be construed as having meanings that are commonly understood by those skilled in the art to which the present disclosure pertains unless especially defined as different meanings otherwise in the present disclosure, and should not be construed as having excessively comprehensive meanings or excessively reduced meanings. Furthermore, if the technological terms used in the present disclosure are wrong technological terms that do not precisely represent the spirit of the present disclosure, they should be replaced with technological terms that may be correctly understood by those skilled in the art and understood. Furthermore, common terms used in the present disclosure should be interpreted in accordance with the definition of dictionaries or in accordance with the context, and should not be construed as having excessively reduced meanings.

Furthermore, an expression of the singular number used in this specification includes an expression of the plural number unless clearly defined otherwise in the context. In this application, terms, such as “include” and “comprise”, should not be construed as essentially including all various components or various steps described in the specification, but the terms may be construed as not including some of the components or steps or as including additional components or steps.

Furthermore, terms including ordinal numbers, such as a “first” and a “second”, which are used in the present disclosure, may be used to describe various components, but the components are not restricted by the terms. The terms are used to only distinguish one component from the other components. For example, a first component may be named a second component without departing from the scope of rights of the present disclosure. Likewise, the second component may be named the first component.

Hereinafter, embodiments according to the present disclosure are described in detail with reference to the accompanying drawings. The same or similar component is assigned the same reference numeral regardless of its reference numeral, and a redundant description thereof is omitted.

Furthermore, in describing the present disclosure, a detailed description of a related known technology will be omitted if it is deemed to make the subject matter of the present disclosure unnecessarily vague. Furthermore, the accompanying drawings are merely intended to make easily understood the spirit of the present disclosure, and the spirit of the present disclosure should not be construed as being restricted by the accompanying drawings.

Hereinafter, a ground reference target and a vicarious radiometric calibration system including the same according to embodiments of the present disclosure are described in detail with reference to the accompanying drawings.

In general, information on the ground, which is observed through a satellite or an airplane, is basically used to check a vegetation index. In general, vicarious radiometric calibration may be performed by using reflectance of a ground reference target in the visible ray (VIS) region or the near-infrared ray (NIR) region.

In particular, upon observation of a temperature of a surface of the earth, the vicarious radiometric calibration is performed by using the quantity of radiant energy that is emitted in the long-wave infrared ray (LWIR) region. Most of natural reference targets that are present on the ground are not suitable as a reference target for vicarious radiometric calibration in the MWIR region. Furthermore, it is not suitable to perform the vicarious radiometric calibration on the MWIR region itself.

The reason for this is that a sensor for observing a temperature on a surface of the earth cannot perform vicarious radiometric calibration in the NWIR region in the daytime and solar background radiation and radiation that is emitted by a reference target itself are mixed at a similar level in the daytime.

Accordingly, vicarious radiometric calibration needs to be performed on the basis of radiation that is emitted by a reference target at night during which solar background radiation is not present. In general, conventionally, vicarious radiometric calibration in the MWIR region is not performed.

A vicarious radiometric calibration system according to an embodiment of the present disclosure is directed to solving such a problem. The vicarious radiometric calibration system proposes a preferred structure of an artificial ground reference target which may be used as a ground reference target on which vicarious radiometric calibration will be performed in the MWIR region, and performs the vicarious radiometric calibration on observed imaged through the artificial ground reference target.

The ground reference target for the vicarious radiometric calibration system according to an embodiment of the present disclosure is designed as a structure in which a spectral reflection factor or spectral emissivity is not greatly changed depending on a wavelength, that is, has a uniform characteristic and a reflectance value thereof can be adjusted as an arbitrary value between 0 and 1 and an emissivity value thereof can also be adjusted between 1 and 0. Hereinafter, the structure of the ground reference target according to an embodiment of the present disclosure is described in detail with reference to the accompanying drawings.

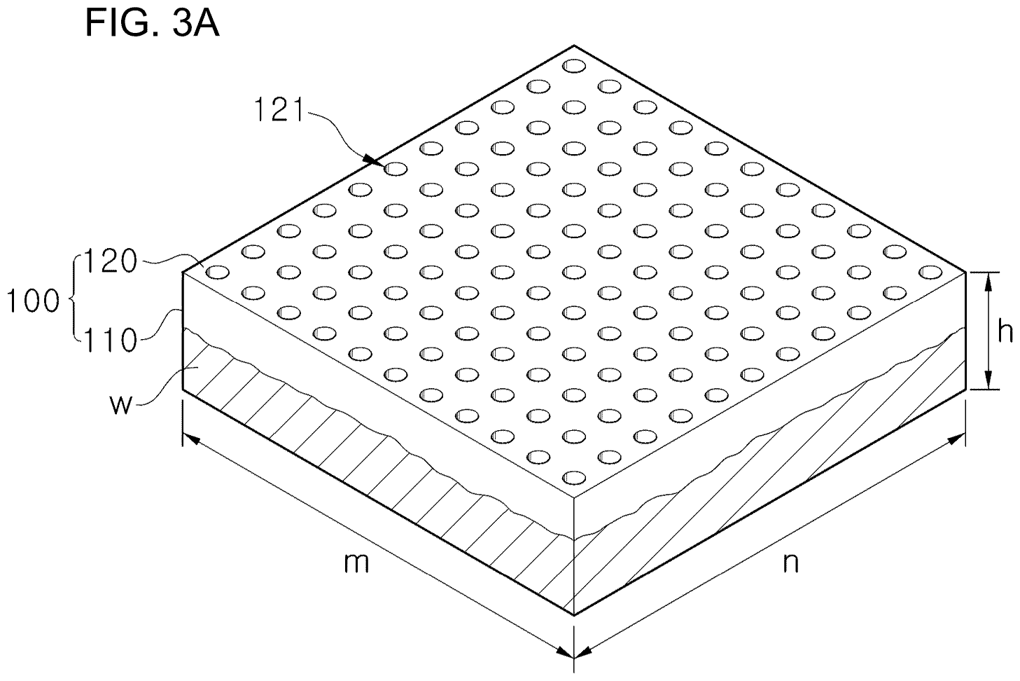

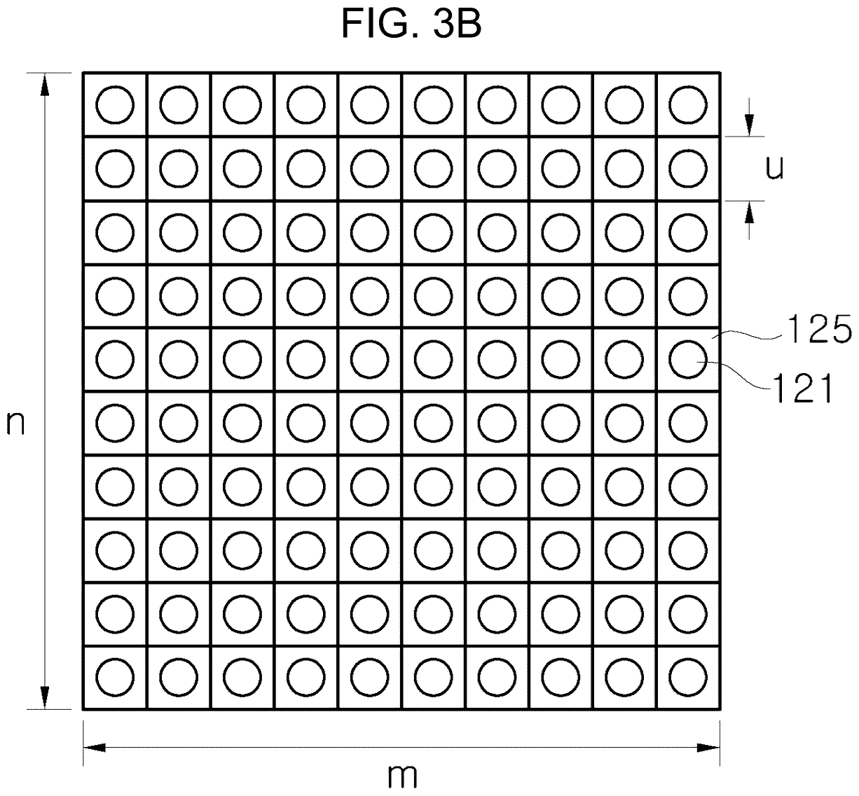

FIGS. 3A and 3B illustrate a perspective view and plan view of an appearance structure of a ground reference target according to an embodiment of the present disclosure.

Referring to FIG. 3A and FIG. 3B, a ground reference target 100 that is included in a vicarious radiometric calibration system according to an embodiment of the present disclosure has a structure that is installed on the ground and that has a rectangular parallelopiped form. The ground reference target 100 may include a body part 110 that has a width of M (M is a rational number) meters, a height of N (N is a rational number) meters, that has an upper part opened, and that has an internal space in which water is accommodated formed therein, and an upper plate part 120 that is coupled to the top of the body part 110, in which a plurality of cells 125 is formed, and that is made of a metal material. A perforation 121 having a predetermined diameter is formed in each of the plurality of cells 125.

The body part 110 is installed on a surface of the ground. Sidewalls each having several meters may be formed on four sides of the body part, respectively. Accordingly, the internal space having a predetermined volume may be formed in the body part. The body part 110 may be made of the same metal material as the upper plate part 120 by considering durability, but the present disclosure is not limited thereto.

A sensor for measuring reflectance is mounted on a satellite or an airplane and observes the ground from an altitude above the Earth's surface. Accordingly, in general, the size of the sensor on the ground corresponding to the size of one pixel of a sensor is several meters. Accordingly, the ground reference target, that is, a landmark according to an embodiment of the present disclosure, may be fabricated to have a size in which width (M)×height (N) are several tens of meters by considering the size of source effect. The ground reference target may also be fabricated to have a height of several meters.

Furthermore, the internal space of the body part 110 may be shielded against the outside because the corners of the upper plate part 120 are coupled to the four sidewalls of the body part 110. Furthermore, the internal space of the body part 110 may be filled with water “w” having a predetermined height. The height of the water “w” may be determined by a relation according to the size with the perforations that are formed in the upper plate part 120.

The upper plate part 120 is a metal plate having a width which may cover the top of the body part 110. The upper plate part 120 may have the same width and height as the body part 110. The corners of the four sides of the upper plate part 120 may be coupled with the tops of the sidewalls of the body part 110, thus forming one structure.

In particular, the upper plate part 120 may be formed of a metal plate the length (u) of one side of which is divided as a unit length, that is, a 1 m×1 m unit and that includes a plurality of cells, and may be coupled to the body part 110 in a form in which the upper plate part 120 covers the entire top of the body part 110. Furthermore, the plurality of cells may be formed in a matrix form in which each of the plurality of cells includes the perforation 121 having a predetermined diameter.

According to such a structure, if the ground reference target 100 from an altitude above the Earth's surface is photographed through a sensor that is mounted on an airplane or a drone, at least one pixel of the sensor can obtain average reflectance or emissivity of the structure by observing the metal region of each of the plurality of cells 125 formed in the upper plate part 120 and the water “w” having a circular shape through the perforations 121.

In this case, reflectance may be determined between 0 and 1 depending on the diameter of the perforation 121 or a material on a surface of the upper plate part.

Furthermore, when the sensor photographs the ground reference target 100 from an altitude above the Earth's surface, the upper plate part 120 of the ground reference target 100 and the water “w” having the circular shape have a form in which the upper plate part 120 and the water “w” have been arranged in a matrix structure.

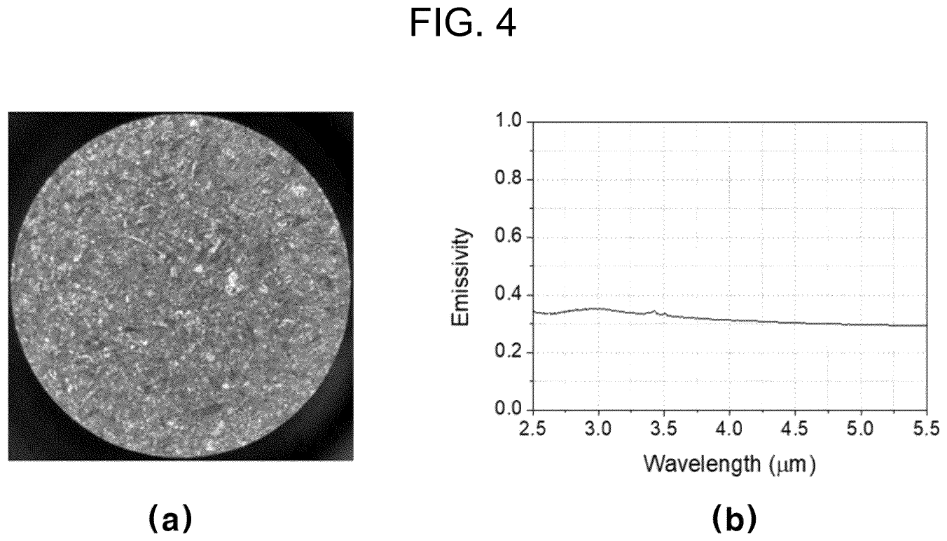

Furthermore, FIG. 4 is a diagram illustrating a surface state upon sanding processing for the metal material that is used in the upper plate part of the ground reference target according to an embodiment of the present disclosure and spectral emissivity thereof. Referring to FIG. 4, a surface of metal that forms the upper plate part of the ground reference target according to an embodiment of the present disclosure may be implemented so that the size of reflectance or emissivity of the surface according to an observation angle is regular through special processing, such as sanding (a).

In particular, it may be seen that as illustrated in FIG. 4, measured spectral emissivity of the surface of metal on which such sanding processing was performed was almost regular between 0.3 and 0.35 in the range of wavelengths of 2.5 μm to 5.5 μm (b).

Furthermore, a designer may make the water “w” more exposed on the surface of the ground reference target 100 by adjusting the diameter of the perforation 121 in the upper plate part 120, and may reduce reflectance or increase emissivity.

The ground reference target 100 according to an embodiment of the present disclosure may be constructed as a structure in which metal and water can be combined so that spectrum characteristics are regular depending on a wavelength in order to arbitrarily adjust the reflectance or emissivity value as described above and a sensor can observe the combined metal and water. In this case, metal and water are materials having relatively uniform spectrum characteristics according to a wavelength in the MWIR region. Accordingly, the size of reflectance or emissivity of the material can be arbitrarily adjusted by properly combining materials having high and low reflectance.

Hereinafter, the structure of the vicarious radiometric calibration system according to an embodiment of the present disclosure is described in detail with reference to the accompanying drawings.

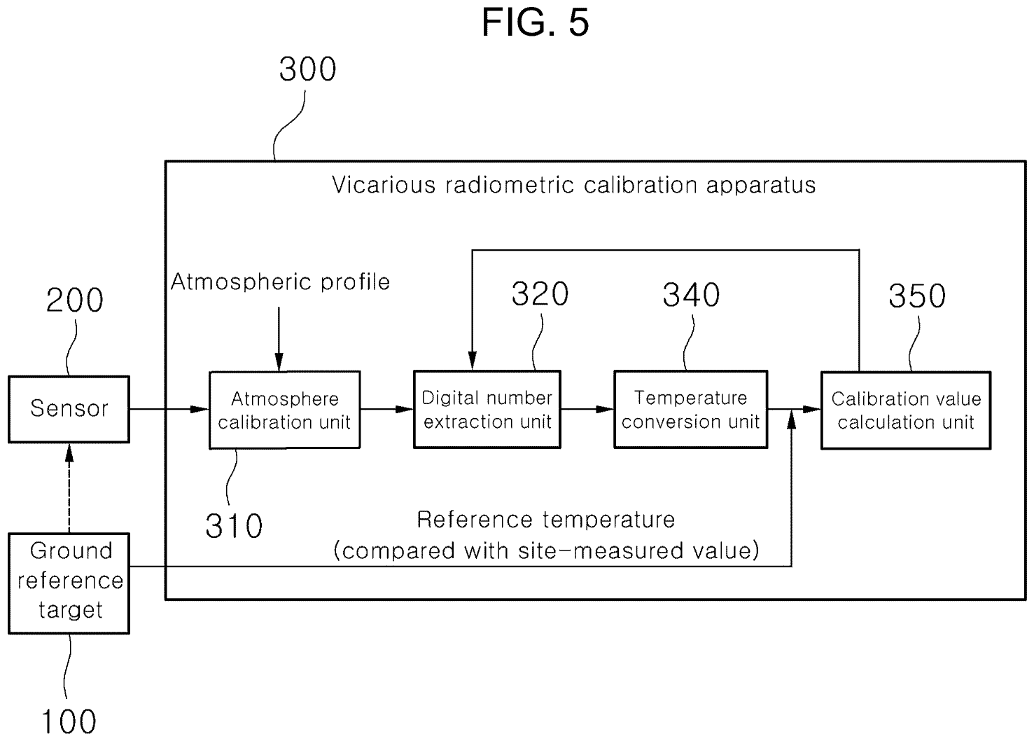

FIG. 5 is a diagram illustrating the structure of the vicarious radiometric calibration system including the ground reference target according to an embodiment of the present disclosure. In the following description, the vicarious radiometric calibration system according to an embodiment of the present disclosure and each of components that constitute the vicarious radiometric calibration system may be implemented in the form of a computer program which may be executed by a known microprocessor, and may be stored in a readable and writable recording medium and mounted on a computer terminal.

Referring to FIG. 5, the vicarious radiometric calibration system according to an embodiment of the present disclosure may include one or more ground reference targets 100 that are installed on the ground and each include at least one metal region and perforation region and in which the plurality of cells 125 each having reflectance or emissivity having a predetermined spectrum characteristic is formed, a sensor 200 that is mounted on an airplane that flies at a predetermined altitude above the Earth's surface, that photographs the ground reference target 100, and that observes average radiance for each cell as each of the plurality of cells corresponds to at least one pixel of the sensor, and a vicarious radiometric calibration apparatus 300 that calibrates the sensor or an image by using the digital number of the sensor that has received an image of the reference target 100 as a reference value.

As described above, the ground reference target 100 has the structure that is installed on the ground and that has a rectangular parallelopiped form, and the plurality of cells having the perforations is formed in the upper plate part 120 of the ground reference target 100 in which water is accommodated and which is formed of the metal plate. Accordingly, the ground reference target 100 may have a structure in which average reflectance by the metal region and the perforation region is observed.

The sensor 200 is a sensor device that photographs the ground from an altitude above the Earth's surface and that is mounted on an airplane. The sensor 200 may photograph the ground reference target 100 installed on the ground. In particular, the sensor 200 may obtain an image by observing average radiance for each cell because at least one pixel of the sensor corresponds to each of the plurality of cells of the ground reference target 100.

The vicarious radiometric calibration apparatus 300 may receive an image that is captured by the sensor 200, and may perform vicarious radiometric calibration through data processing based on the image digital number of the ground reference target 100 having current atmosphere conditions compensated for.

In particular, the vicarious radiometric calibration apparatus 300 according to an embodiment of the present disclosure may include the following components in order to perform vicarious radiometric calibration on an image captured by the sensor 200.

Specifically, an atmosphere calibration unit 310 may receive an MWIR image that is captured by a sensor mounted on an airplane or a drone that flies above the Earth's surface, and may perform atmosphere calibration with reference to an atmospheric profile, such as a temperature, humidity, and pressure according to current atmosphere conditions.

Specifically, the MWIR image obtained by the sensor requires a process of normalizing information within the MWIR image into a common scale on which the information may be compared. Such a normalization process may be considered as atmosphere radiometric calibration that converts a digital number (DN) within the MWIR image into a radiance value at the top of the atmosphere.

A digital number extraction unit 320 may extract the digital number (DN) of the sensor from which all influences according to the current atmosphere have been removed through the atmosphere radiometric calibration process for the MWIR image, and may convert the digital number (DN) into radiance of the ground reference target.

A temperature conversion unit 340 may convert the radiance of the ground reference target according to an embodiment of the present disclosure into a radiation temperature. To this end, the temperature conversion unit 340 may read a measured value of emissivity of the ground reference target with reference to a structure DB, and may convert the radiance into the radiation temperature.

A calibration value calculation unit 350 may calculate a calibration value (ODN) for vicarious radiometric calibration by comparing the converted radiation temperature and a reference temperature, that is, a radiation temperature according to the original emissivity characteristic of the ground reference target. Furthermore, the calibration value (ODN) may be provided to digital number extraction unit 320 for reference when the digital number (DN) is extracted, thus implementing the vicarious radiometric calibration.

Although many contents have been described in detail in the description, such contents should be interpreted as an example of a preferred embodiment rather than limiting the scope of the disclosure. Accordingly, the present disclosure should not be determined by the aforementioned embodiments, but should be determined by the claims and equivalents of the claims.

### DESCRIPTION OF REFERENCE NUMERALS

100: ground reference target 110: body part
120: upper plate part 121: perforation
125: (plurality of) cells 200: sensor
300: vicarious radiometric calibration system
310: atmosphere calibration unit
320: digital number extraction unit
340: temperature conversion unit
350: calibration value calculation unit

What is claimed is:

1. A ground reference target, wherein:
the ground reference target is a structure that is installed on a ground, and
the ground reference target comprises:
a body part that has a width of M (M is a rational number) meters, a height of N (N is a rational number) meters, that has an upper part opened, and that has an internal space in which water is accommodated formed therein; and
an upper plate part that is coupled to a top of the body part, in which a plurality of cells is formed, and that is made of a metal material,
wherein a perforation having a predetermined diameter is formed in each of the plurality of cells, and
average radiance of a metal region and a perforation region for each cell is observed because at least one cell corresponds to one pixel of a sensor upon photographing of the sensor.

2. The ground reference target of claim 1, wherein reflectance or emissivity of each of the plurality of cells is determined by a diameter of the perforation.

3. The ground reference target of claim 2, wherein a surface of the upper plate part is processed by sanding or a processing method for diffusion reflection other than the sanding so that a size of reflectance or emissivity is regular according to an observation angle.

4. The ground reference target of claim 3, wherein:
the reflectance is determined to have a number between 0 and 1 depending on the diameter of the perforation or a material on a surface of the upper plate part, and
a sum of the reflectance and the emissivity is 1.

5. A vicarious radiometric calibration system comprising:
one or more ground reference targets installed on a ground and each comprising at least one metal region and perforation region and in which a plurality of cells each having predetermined reflectance or emissivity is formed;
a sensor mounted on an airplane that flies at a predetermined altitude above an Earth's surface and configured to photograph the ground reference target and to obtain an image in which average radiance for each cell is observed as each of the plurality of cells corresponds to at least one pixel of the sensor; and
a vicarious radiometric calibration apparatus configured to receive the image and to perform vicarious radiometric calibration that converts a radiance value of the ground reference target into a digital number (DN).

6. The vicarious radiometric calibration system of claim 5, wherein the ground reference target comprises:
a body part that has a width of M (M is a rational number) meters, a height of N (N is a rational number) meters, that has an upper part opened, and that has an internal space in which water is accommodated formed therein; and
an upper plate part that is coupled to a top of the body part, in which a plurality of cells each having a perforation having a predetermined diameter is formed, and that is made of a metal material.

7. The vicarious radiometric calibration system of claim 6, wherein the vicarious radiometric calibration apparatus comprises:
an atmosphere calibration unit configured to receive the image obtained by the sensor and to perform atmosphere calibration with reference to an atmospheric profile;
a digital number extraction unit configured to extract the DN from which the sensor and an influence of current atmosphere have been removed from the image to which the atmosphere calibration has been applied and to convert the DN into radiance;
a temperature conversion unit configured to convert the radiance into a radiation temperature based on a measured value of emissivity of the ground reference target; and
a calibration value calculation unit configured to calculate a calibration value (ODN) by comparing the radiation temperature and a reference radiation temperature and to calibrate the DN by providing the calibration value (SDN) to the digital number extraction unit.

8. The vicarious radiometric calibration system of claim 7, wherein the atmospheric profile comprises one or more of a temperature, humidity, and pressure according to current atmosphere conditions.
